(19) United States
(12) Patent Application Publication
(10) Pub. No.: US 2019/0389443 A1
(43) Pub. Date: Dec. 26, 2019

(54) METHOD FOR DETECTING BRAKE WEAR IN A VEHICLE

(71) Applicant: Robert Bosch GmbH, Stuttgart (DE)

(72) Inventors: Bertram Foitzik, IIsfeld (DE); Jonathan Schnur, Bietigheim-Bissingen (DE)

(21) Appl. No.: 16/427,696

(22) Filed: May 31, 2019

(30) Foreign Application Priority Data
Jun. 21, 2018 (DE) 102018210156.6

(51) Int. Cl. B60T 8/58; B60T 17/22; B60T 8/171

(52) U.S. Cl. CPC B60T 8/58; B60T 17/221; B60T 2250/04; B60T 2240/00; B60T 8/171

(57) ABSTRACT

A method for detecting brake wear in a vehicle includes ascertaining a condition variable and generating a warning signal if multiple brake judder events are detected from the profile of the condition variable.

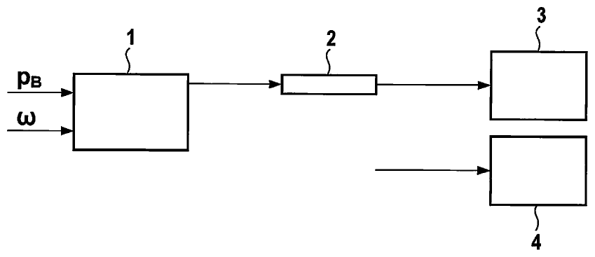

### CROSS-REFERENCE TO RELATED APPLICATIONS

The present application claims priority under 35 U.S.C. § 119 to DE 10 2018 210 156.6, filed in the Federal Republic of Germany on Jun. 21, 2018, the content of which is hereby incorporated by reference herein in its entirety.

### FIELD OF THE INVENTION

The present invention relates to a method for detecting brake wear in a vehicle.

### BACKGROUND

So-called brake judder in vehicle brakes is known, in which higher frequency braking force fluctuations occur during a braking operation, which can arise, for example, due to thickness variations of the brake disk or an improper installation of the brake disk.

A method for suppressing brake judder in a vehicle brake is described in JP 2016 146 706 A. As soon as brake judder is detected, a damping torque is generated in the vehicle using a regeneration brake, which is directed counter to the vibrations of the brake judder.

### SUMMARY

According to an example embodiment of the present invention, a method is performed for detection of brake wear in a vehicle resulting from brake judder. Brake judder, which occurs during a braking operation in the vehicle upon actuation of the vehicle brake, is a superimposed vibration which is reflected in a driving condition variable or a brake condition variable and is superimposed on the basic profile of the relevant driving condition variable or brake condition variable. Brake judder can be a so-called hot judder or a cold judder, the hot judder being characterized by local density changes in the brake disk of the vehicle brake due to a heat input, while the cold judder is due to thickness variations of the brake disk or an oblique-angled installation of the brake disk. During brake judder, vibrations having a frequency up to several hundred Hz can arise. As a result, various components in the vehicle, in particular in the vehicle brake, although possibly also outside the vehicle brake, such as in the steering system of the vehicle, can be subjected to an elevated load which results in a reduction of the component service life.

In an example, a brake judder which can be present during a braking operation is detected on the basis of the profile of a driving condition variable or a brake condition variable. For this purpose, the profile of the driving condition variable and/or of the brake condition variable are/is investigated for the presence of a profile which is typical for brake judder. If it is detected that a brake judder has occurred during a braking operation, a brake judder counter, which indicates the total number of brake judders, is incremented by the value 1. A check is carried out to determine whether the number of detected brake judder events exceeds a whole-number limiting value of 2 or higher. If this is the case, a warning signal is generated, which can be further processed, for example, displayed to the driver or, during a visit to the repair shop, provides an appropriate indication regarding the elevated number of brake judder events. Thereupon, components subjected to increased wear in the case of repeated brake judder can be investigated and, if necessary, repaired or replaced.

Using the method according to the present invention, a case of increased brake wear due to brake judder can therefore be detected. In addition, it is possible to also detect the wear of further components that do not directly belong to the braking system of the vehicle, but which are likewise subjected to an elevated load during brake judder, for example, in the steering system of the vehicle.

According to an example embodiment, a brake condition variable is investigated for brake judder. The brake condition variable is, in particular, a brake pressure signal of a hydraulic vehicle brake in the vehicle. The brake judder is expressed in the profile of the brake pressure signal as high-frequency vibration superimposed on the basic profile of the brake pressure, which occurs within a frequency band typical for brake judder. This superimposed vibration can be identified in the profile of the brake pressure signal, whereupon the presence of brake judder can be inferred and the appropriate brake judder counter can be incremented.

Additionally or alternatively, it is also possible to investigate a driving condition variable, for example, a wheel speed signal, for the presence of brake judder. In the driving condition variable as well, the brake judder can appear as vibration superimposed on the basic profile, which is identified on the basis of the frequency and possibly the amplitude. It can be advantageous to investigate multiple wheel speed signals of various wheels of the vehicle for brake judder, even when it suffices, in principle, to investigate only one wheel speed signal. Moreover, it is possible to investigate a brake condition variable, in particular a brake pressure signal, and, in addition, a driving condition variable, in particular a wheel speed signal, for brake judder. Alternatively, it is also possible to investigate either only a brake condition variable, in particular a brake pressure signal, or only a driving condition variable, in particular a wheel speed signal, with respect to the presence of brake judder.

The frequency in which the brake judder is typically expressed depends on the vehicle speed. The frequency during hot judder and during cold judder can be different. During cold judder, the typical brake judder frequency is twice as high as during hot judder. In the first harmonic (hot judder), the typical, speed-dependent frequency results from the ratio of the vehicle speed with respect to the angular frequency ω. The typical frequency in the second harmonic (cold judder) is twice as high.

It can be advantageous to define a frequency range within which the superimposed vibration frequency must lie for brake judder to be present.

According to an example embodiment, the brake judder is identified as present only for the case in which the superimposed vibration signal has an amplitude which exceeds a limiting value. As a result, it is ensured that vibrations which lie in the brake judder frequency but have a smaller amplitude will not be taken into consideration. In this way, vibrations that randomly lie in the correct frequency range but have only a small amplitude are ruled out as brake judder or will at least be disregarded.

According to an example embodiment, only one brake judder event, at most, is counted per braking operation. The brake judder that occurs during a braking operation is counted as a single event, regardless of the time period of the brake judder during the braking operation and, advantageously, also regardless of whether two separately occurring brake judder events are present during the same braking operation.

Alternatively, it is also possible to evaluate each continuous brake judder event, multiple such brake judder events occurring during one braking operation. Moreover, it is possible to evaluate a brake judder event as a function of time, for example, in the form of counting a brake judder event only when it lasts longer than a minimum period of time.

The method can be carried out in an automatic braking operation executed independently of the driver, for example, within the scope of a driver assistance system. The braking operation can be carried out semi-automatically or fully automatically. In a semi-automatic braking operation, the vehicle brake is actuated by the driver and, additionally, a supplemental brake intervention is carried out independently of the driver, for example, in order to modify the brake pressure. In a braking operation carried out fully automatically, the brake intervention takes place completely using the driver assistance system and without actuation of the vehicle brake by the driver.

Moreover, the present invention relates to a method for carrying out a fully-automatic or semi-automatic braking operation that can build upon the above-described method for detecting brake wear on the basis of multiple brake judders. It is also possible, however, to carry out the method for implementing a fully-automatic or semi-automatic braking operation independently of the method for detecting brake wear due to multiple brake judder events.

The method for carrying out a fully automatic or semi-automatic braking operation relates to braking operations including brake judder expressed in the form of a high-frequency, superimposed vibration in a driving condition variable and/or a brake condition variable. In the method according to the present invention, in order to avoid the situation in which the superimposed vibration, resulting from the brake judder, in the profile of the driving condition variable or the brake condition variable results in an intensive regulating activity in a control system that is actuated in order to carry out the method, and associated component loads and adverse effects on comfort, the driving condition variable or the brake condition variable is subjected to a filtering or a compensation in order to eliminate the brake judder. As a result, a smoothing of the profile of the relevant driving condition variable or brake condition variable is achieved in a way which this variable would assume without the brake judder. The smoothed driving condition variable or brake condition variable is subsequently used as the basis for the semi-automatic or fully automatic braking operation and, for example, is routed to a vehicle controller.

The smoothing of the profile of the driving condition variable or the brake condition variable is achieved, for example, using a low-pass filter. Alternatively, it is also possible to achieve a smoothing by superimposing a further signal that is phase-shifted, for example, with respect to the driving condition variable or the brake condition variable. The smoothed condition variable, which is used as the basis for the semi-automatic or fully automatic braking operation, simplifies braking control operations, provides for a lesser loading of the components, and enhances driving comfort.

The present invention also relates to a control unit for carrying out the above-described methods. The various method steps, using which actuating signals are generated in order to control a brake actuator system in the braking system of the vehicle, take place in the control unit.

Moreover, the present invention relates to a vehicle including such a control unit and including a brake actuator system in the braking system of the vehicle, which is activated by the control unit in order to carry out a fully automatic or semi-automatic braking operation. The braking system is, in particular, the hydraulic vehicle brake.

The present invention also relates to a computer program product including a program code designed for carrying out the above-described method steps. The computer program product runs in the above-described control unit.

Further advantages and example embodiments are to be derived from the claims and the following description.

### BRIEF DESCRIPTION OF THE DRAWING

The FIGURE is a flowchart that illustrates a method for detecting brake wear due to repeated brake judder, according to an example embodiment of the present invention.

### DETAILED DESCRIPTION

The flowchart illustrates a method sequence for detecting brake wear in a vehicle for the case that brake judder repeatedly occurs in the vehicle brake that is designed as a hydraulic brake. In a first block 1, which contains the detection logic for establishing brake judder, brake pressure p_{B} of the hydraulic vehicle brake as well as at least one wheel speed w are supplied as input signals. A brake judder event can be detected from the profile of brake pressure signal p_{B} if a vibration is superimposed on the basic profile of the brake pressure signal, the frequency of which lies within a defined frequency range and the amplitude of which exceeds an amplitude limiting value. Such brake judder usually occurs either as hot judder, which is characterized by a local material deformation due to heat input in the brake disk, or as cold judder which is induced due to thickness differences in the brake disk or an oblique installation of the brake disk. The frequency typical for hot judder is in the magnitude of f=v/(2 πr), where v is the vehicle speed and r is the dynamic rolling radius of the tire. In the case of cold judder, the frequency that results is twice as great as the above-described frequency. The frequencies are mean values, a hot judder or a cold judder being present when the frequency of the superimposed vibration moves within a frequency range about the mean frequency.

The brake judder is preferably ascertained on the basis of brake pressure signal p_{B}, where hot judder or cold judder can be differentiated on the basis of wheel speed signal w.

Alternatively, it is also possible to directly infer a brake judder event on the basis of the profile of wheel speed signal w.

If it is established in the logic in block 1, that a brake judder has occurred during a braking operation, a braking judder counter is incremented by the value 1 in next block 2. According to an example embodiment, the value of the counter is incremented by the value 1 only once per braking operation, regardless of the duration of the brake judder and regardless of whether brake judder occurs one time or multiple times during an on-going braking operation.

The brake judder counter of block 3 is used for a prompt to the driver to visit a repair shop. This takes place for the case, in particular, in which the brake judder counter exceeds a limiting value. Additionally or alternatively, it is also possible, according to block 4, to store the brake judder counter internally, for example, in a control unit and to make it available during the next visit to the repair shop, whereupon measures for eliminating the brake judder, for example, on the brake disks of the vehicle, can be carried out, if necessary.

The brake judder counter represented in block 3 and stored in block 4, represents a warning signal or can result in the output of a warning signal if the number of the detected brake judder events in the brake judder counter exceeds a limiting value.

What is claimed is:

1. A method for detecting brake wear in a vehicle, the method comprising:
ascertaining at least one of a driving condition variable and a braking condition variable;
based on a profile of the at least one of the driving condition variable and the braking condition variable, detecting that a number of occurrences of brake judder events exceeds a first predefined threshold; and
in response to the detection of the number exceeding the predefined threshold, generating a warning signal indicating increased brake wear.

2. The method of claim 1, wherein the at least one variable includes a wheel speed signal.

3. The method of claim 1, wherein the at least one variable includes a brake pressure signal of a hydraulic vehicle brake in the vehicle.

4. The method of claim 1, wherein:
the detection of at least one of the occurrences of the brake judder events is by detecting a superimposition on the at least one variable of a signal, a frequency (f) of which is one or two times v/(2 πr);
v is the vehicle speed; and
r is a dynamic rolling radius of the tire.

5. The method of claim 1, wherein the detection of at least one of the occurrences of the brake judder events is by detecting a superimposition on the at least one variable of a signal that has an amplitude that exceeds a second predefined threshold.

6. The method of claim 1, wherein, at most, only one brake judder event is counted per braking operation.

7. The method of claim 1, further comprising executing a semi-automatic or fully-automatic braking operation based on the brake judder events.

8. A method for carrying out a fully automatic or semi-automatic braking operation of a vehicle, the method comprising:
ascertaining at least one of a driving condition variable and a braking condition variable;
producing a smoothed signal by subjecting the at least one of the driving condition variable and the braking condition variable to a filtering or a compensation for occurrences of brake judder events identified by superimpositions on a profile of the at least one of the driving condition variable and the braking condition variable; and
performing the braking operation based on the smoothed signal.

9. A control unit comprising a processor, wherein the processor is configured to perform a method for detecting brake wear in a vehicle, the method comprising:
ascertaining at least one of a driving condition variable and a braking condition variable;
based on a profile of the at least one of the driving condition variable and the braking condition variable, detecting that a number of occurrences of brake judder events exceeds a first predefined threshold; and
in response to the detection of the number exceeding the predefined threshold, generating a warning signal indicating increased brake wear.

10. A control unit comprising a processor, wherein the processor is configured to perform a method for carrying out a fully automatic or semi-automatic braking operation of a vehicle, the method comprising:
ascertaining at least one of a driving condition variable and a braking condition variable;
producing a smoothed signal by subjecting the at least one of the driving condition variable and the braking condition variable to a filtering or a compensation for occurrences of brake judder events identified by superimpositions on a profile of the at least one of the driving condition variable and the braking condition variable; and
performing the braking operation based on the smoothed signal.

11. A vehicle comprising:
a brake actuator; and
a control unit that includes a processor, wherein the processor is configured to perform a method for carrying out a fully automatic or semi-automatic braking operation of a vehicle, the method comprising:
ascertaining at least one of a driving condition variable and a braking condition variable;
producing a smoothed signal by subjecting the at least one of the driving condition variable and the braking condition variable to a filtering or a compensation for occurrences of brake judder events identified by superimpositions on a profile of the at least one of the driving condition variable and the braking condition variable; and
controlling the brake actuator to perform the braking operation based on the smoothed signal.

12. A non-transitory computer-readable medium on which are stored instructions that are executable by a processor and that, when executed, causes the processor to perform a method for detecting brake wear in a vehicle, the method comprising:
ascertaining at least one of a driving condition variable and a braking condition variable;
based on a profile of the at least one of the driving condition variable and the braking condition variable, detecting that a number of occurrences of brake judder events exceeds a first predefined threshold; and
in response to the detection of the number exceeding the predefined threshold, generating a warning signal indicating increased brake wear.

13. A non-transitory computer-readable medium on which are stored instructions that are executable by a processor and that, when executed, causes the processor to perform a method for carrying out a fully automatic or semi-automatic braking operation of a vehicle, the method comprising:
ascertaining at least one of a driving condition variable and a braking condition variable;
producing a result by subjecting the at least one of the driving condition variable and the braking condition variable to a filtering or a compensation for occurrences of brake judder events identified by superimpositions on a profile of the at least one of the driving condition variable and the braking condition variable; and
performing the braking operation based on the result.
